(19) United States
(12) Patent Application Publication
(10) Pub. No.: US 2026/0319075 A1
(43) Pub. Date: Oct. 15, 2026

(54) MEASUREMENT APPARATUS, PROCESSING APPARATUS, AND MEASUREMENT METHOD

(71) Applicant: CANON KABUSHIKI KAISHA, Tokyo (JP)

(72) Inventors: Shunichi WAKASHIMA, Tokyo (JP); Koichi FUKUDA, Tokyo (JP); Kohei OKAMOTO, Kanagawa (JP); Takashi HANASAKA, Tokyo (JP)

(21) Appl. No.: 19/695,270

(22) Filed: Jun. 2, 2026

Related U.S. Application Data
(63) Continuation of application No. PCT/JP2024/030183, filed on Aug. 26, 2024.

(30) Foreign Application Priority Data
Dec. 5, 2023 (JP) 2023-204996

(51) Int. Cl. G01S 7/4865; G01S 7/481; G01S 7/4863; G01S 17/10

(52) U.S. Cl. CPC G01S 7/4865; G01S 7/4812; G01S 7/4815; G01S 7/4816; G01S 7/4863; G01S 17/10

(57) ABSTRACT

A measurement apparatus includes light emitting and receiving element arrays, an optical system, a light splitting element including a splitter configured to split light from the light emitting element array into irradiation light to be irradiated onto an object via the optical system and reference light to be guided to the light receiving element array, a processor configured to acquire information on the object using a first time from an instruction to the light emitting element array to reception of the reference light by the light receiving element array and a second time from the instruction to reception of the signal light by the light receiving element array, and a reflector configured to reflect the reference light from the splitter back to the splitter. The reference light from the reflector is guided to the light receiving element array via the splitter.

### CROSS-REFERENCE TO RELATED APPLICATIONS

This application is a Continuation of International Patent Application No. PCT/JP2024/030183, filed on Aug. 26, 2024, which claims the benefit of Japanese Patent Application No. 2023-204996, filed on Dec. 5, 2023, both of which are hereby incorporated by reference herein in their entirety.

### BACKGROUND

### Field of the Technology

The present disclosure relates to a measurement apparatus using a time of flight (ToF) method, a processing apparatus, and a measurement method.

### Description of the Related Art

The ToF method measures a distance to an object (object distance) and the like based on a time from when light is emitted toward the object to when reflected light from the object is detected. Japanese Patent Application Laid-Open No. 2014-174069 discloses a measurement apparatus that includes a detector configured to detect a portion of irradiation light from a laser light source as reference light and a detector configured to detect signal light generated when the irradiation light is reflected by an object, and improves the measurement accuracy using cross-correlation between the reference light and the signal light.

### SUMMARY

A measurement apparatus according to one aspect of the present disclosure includes a light emitting element array including a plurality of light emitting elements, a light receiving element array including a plurality of light receiving elements, an optical system, a light splitting element including a splitter configured to split light from the light emitting element array into irradiation light to be irradiated onto an object via the optical system and reference light to be guided to the light receiving element array, the light splitting element being configured to guide, via the splitter, signal light, which is reflected by the object among the irradiation light and incident via the optical system, to the light receiving element array, one or more memories storing instructions, one or more processors that, upon execution of the instructions, operate to acquire information on the object using a first time from a light emission instruction to the light emitting element array to reception of the reference light by the light receiving element array and a second time from the light emission instruction to reception of the signal light by the light receiving element array, and a reflector configured to reflect the reference light from the splitter back to the splitter. The reference light from the reflector is guided to the light receiving element array via the splitter. A processing apparatus having the above measurement apparatus also constitutes another aspect of the present disclosure. A measurement method corresponding to the above measurement apparatus also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configuration of a distance measuring apparatus according to a first embodiment.

FIG. 2 is a diagram illustrating the configurations of a light source unit and a light source control unit according to the first embodiment.

FIG. 3 is a diagram illustrating the configuration of a measurement unit according to the first embodiment.

FIG. 4 is a diagram illustrating the configuration of a pixel of a light receiving element array according to the first embodiment.

FIG. 5 is a diagram illustrating the configuration of a time-to-digital converter (TDC) array unit of the measurement unit.

FIG. 6 is a diagram illustrating the configuration of an oscillator in a TDC of the TDC array unit.

FIG. 7 is a diagram illustrating an output signal of a buffer in the TDC and an internal signal of the oscillator.

FIG. 8 is a diagram illustrating changes in a SPAD cathode potential, a pixel output signal, a synchronization clock, a synchronization clock count value, an oscillation start/stop signal, an oscillator output, and an oscillation count value in the first embodiment.

FIG. 9 is an enlarged view of a part of FIG. 8.

FIG. 10 is a diagram illustrating the configuration of an oscillation adjustment voltage generation circuit according to the first embodiment.

FIGS. 11A to 11D are views of a beam splitter, a light emitting element array, a light receiving element array, and an imaging lens in the first embodiment.

FIG. 12 is a flowchart illustrating distance measuring processing according to the first embodiment.

FIG. 13 is a diagram illustrating histograms of reference light and signal light in the first embodiment.

FIGS. 14A to 14D are views of a beam splitter, a light emitting element array, a light receiving element array, and an imaging lens in a second embodiment.

FIG. 15 is a diagram illustrating histograms of reference light and signal light in the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the present disclosure.

The measurement apparatus disclosed in Japanese Patent Application Laid-Open No. 2014-174069 requires an optical system for detecting the reference light separately from an optical system for receiving the signal light, which increases the size of the measurement apparatus.

### First Embodiment

### Configuration of Distance Measuring Apparatus

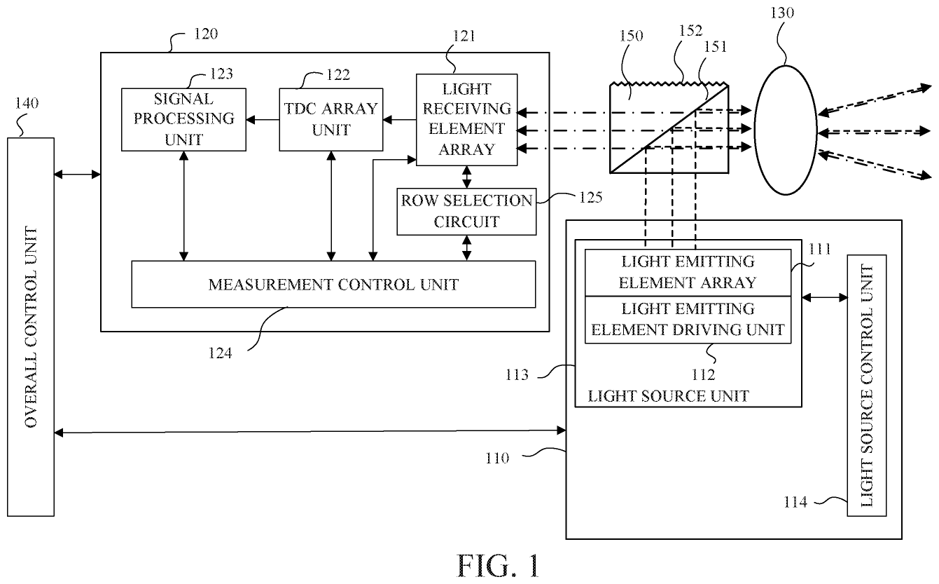

FIG. 1 illustrates the configuration of a distance measuring apparatus as a measurement apparatus according to a first embodiment of the present disclosure.

In FIG. 1, solid lines connecting components indicate signal transmission, dashed lines indicate irradiation light projected toward an object, and alternate long and short dash lines indicate signal light that is reflected light from the object.

The distance measuring apparatus includes a projection unit 110, a measurement unit 120, an imaging lens 130 serving as an optical system, an overall control unit 140 serving as one or more memories storing instructions (specified in a computer program), such as a ROM and RAM, and one or more processors, such as a CPU, MPU, or the like. The control unit 140, upon execution of the instructions, operates to acquire information on the object using a first time from a light emission instruction to a light emitting element array 111 described later, to the reception of the reference light by a light receiving element array 121 described later, and a second time from the light emission instruction to the reception of the signal light by the light receiving element array 121. The distance measuring apparatus further includes a beam splitter 150 serving as a light splitting element. The projection unit 110 includes a light source unit 113 and a light source control unit 114. The light source unit 113 includes a light emitting element array 111 in which a plurality of light emitting elements are arranged in a two-dimensional array and a light emitting element driving unit 112 that drives the respective light emitting elements.

The measurement unit 120 includes a light receiving element array 121 including a plurality of light receiving elements, a Time-to-Digital Converter (TDC) array unit 122, a signal processing unit 123, a measurement control unit 124, and a row selection circuit 125. In the light receiving element array 121, the plurality of light emitting elements are arranged two-dimensionally so as to form a plurality of rows.

A band-pass filter may be disposed on the light receiving element array so as to transmit light in a wavelength range including the wavelength of light emitted from each light emitting element and to reflect or absorb light in other wavelength ranges.

The beam splitter 150 includes a half-mirror 151 serving as a splitter that transmits a part of incident light and reflects the remainder, and a reflection structure portion 152 serving as reflector.

Irradiation light in the form of pulse light emitted from the plurality of light emitting elements of the light emitting element array 111 in the light source unit 113 is projected in different directions in space via the imaging lens 130. Among the irradiation light, signal light reflected from an object in space is received, via the imaging lens 130, by a light receiving element corresponding to the light emitting element that emitted light among the plurality of light receiving elements of the light receiving element array 121. In the light receiving element array 121, the plurality of light receiving elements are arranged two-dimensionally so as to form a plurality of rows.

The time from when the light emitting element emits light to when the signal light is received by the light receiving element is a time of flight (ToF), and this time of flight is calculated using measurement results obtained by the TDC array unit 122. At this time, in order to reduce distance measurement errors caused by noise components due to ambient light and dark counts, noise in the measurement circuit, and light emission delay of the light emitting element from the issuance of a light emission instruction (start of time counting), emission of the irradiation light and time counting are repeatedly performed. Then, the signal processing unit 123 generates a histogram of measurement results and performs removal of noise components and averaging of the measurement results. The light emission delay time of the light emitting element from the light emission instruction varies depending on individual differences and temperature characteristics of the light emitting element driving unit 112, the light emitting element, the light receiving element, the TDC array unit 122, and buffers in signal transmission paths. Therefore, a part of irradiation light actually emitted from the light emitting element is detected as reference light, and the light emission delay time from the light emission instruction time to the detection time of the reference light is subtracted from the time from the light emission instruction time to the detection time of the signal light, thereby calculating the time of flight ToF.

The time of flight ToF acquired in this manner is substituted into equation (1) below to obtain a distance L to the object with high accuracy. In equation (1), c is the speed of light.

L=ToF×c/2 (1)

Using ToF, not only distance information (L) to the object but also information on the object, including the shape of the object, can be obtained.

### Projection Unit

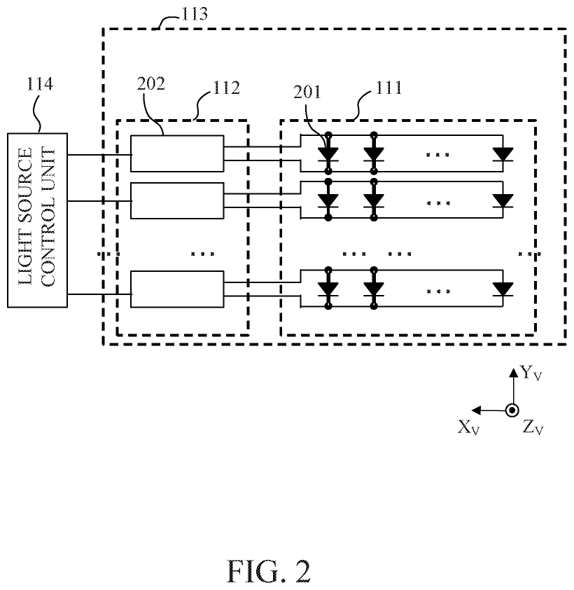

FIG. 2 illustrates an example configuration of the light source unit 113 and the light source control unit 114 that constitute the projection unit 110. In the light emitting element array 111, a plurality of Vertical Cavity Surface Emitting LASERs (VCSELs) serving as light emitting elements 201 are arranged in a two-dimensional array on a substrate so as to form a plurality of rows. The light emitting element driving unit 112 is configured such that row driving circuits 202 are arranged in a one-dimensional array.

The light emitting element is not limited to a VCSEL, but may use an element capable of being integrated in a one-dimensional or two-dimensional array. Examples include an edge-emitting laser and a light emitting diode (LED). In a case where an edge emitting laser is used instead of a VCSEL array as the light emitting element array, a laser bar in which lasers are arranged one-dimensionally on a substrate or a laser bar stack obtained by stacking such laser bars to form a two-dimensional light emitting element array configuration may be used. Further, in a case where LEDs are used as the light emitting elements, LEDs arranged in a two-dimensional array on a substrate may be used.

In the distance measuring apparatus according to the present embodiment, in order to suppress the influence of ambient light, the wavelength of light emitted from the light emitting elements may be in the near-infrared band. In this case, the VCSEL is fabricated by a semiconductor process using materials used in conventional edge emitting lasers or surface-emitting lasers, and a GaAs-based semiconductor material may be used as a main material for emitting light having a wavelength in the near-infrared band. In this case, a Distributed Bragg Reflector (DBR) forming a dielectric multilayer mirror constituting the VCSEL may be formed by alternately and periodically stacking two thin films made of materials having different refractive indices (GaAs/AlGaAs). The wavelength of light emitted from the VCSEL can be changed by adjusting combinations and compositions of elements of compound semiconductors.

Further, each VCSEL constituting the VCSEL array has electrodes for injecting electrons and holes into an active layer. The electrodes are shared by a plurality of VCSELs in a row direction and are connected to the row driving circuits 202 arranged in the respective rows. By operating only a specific row driving circuit 202 in the light emitting element driving unit 112, current is injected only into a plurality of VCSELs (first light emitting elements) belonging to a specific row (light emitting element row), and the plurality of VCSELs in the specific row can be caused to emit light simultaneously.

By switching the row driving circuit 202 to be operated, the plurality of rows of VCSELs can be sequentially caused to emit light row by row.

### Configuration of Measurement Unit

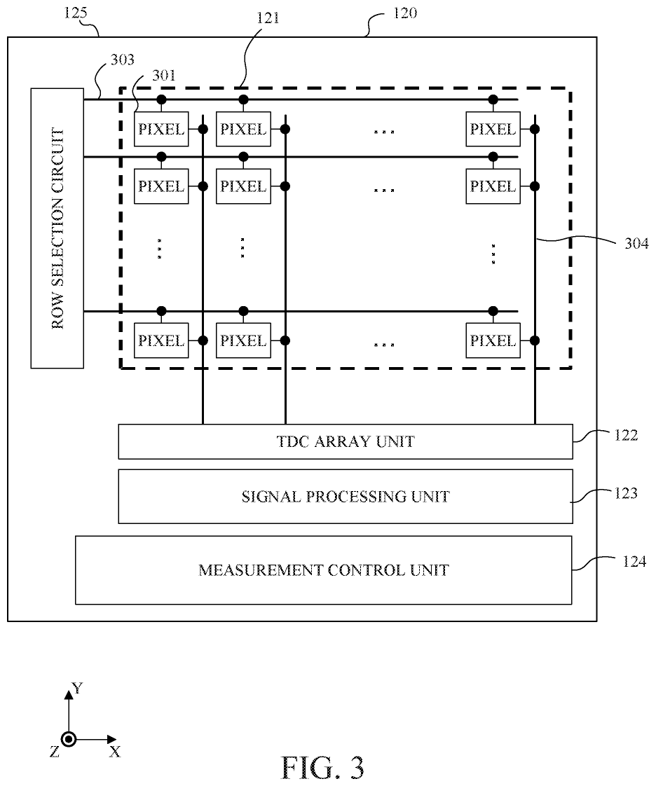

FIG. 3 illustrates the configuration of the measurement unit 120. The measurement unit 120 includes a light receiving element array 121 having a plurality of pixels 301 arranged in a two-dimensional array, a TDC array unit 122, a signal processing unit 123, and a measurement control unit 124. Further, the measurement unit 120 includes a row selection circuit 125 for enabling only a specific row, row selection pulse wiring 303 that outputs an output signal of the row selection circuit 125 to the pixels 301, and a pixel output line 304 that outputs pixel output signals from the pixels 301 to the TDC array unit 122.

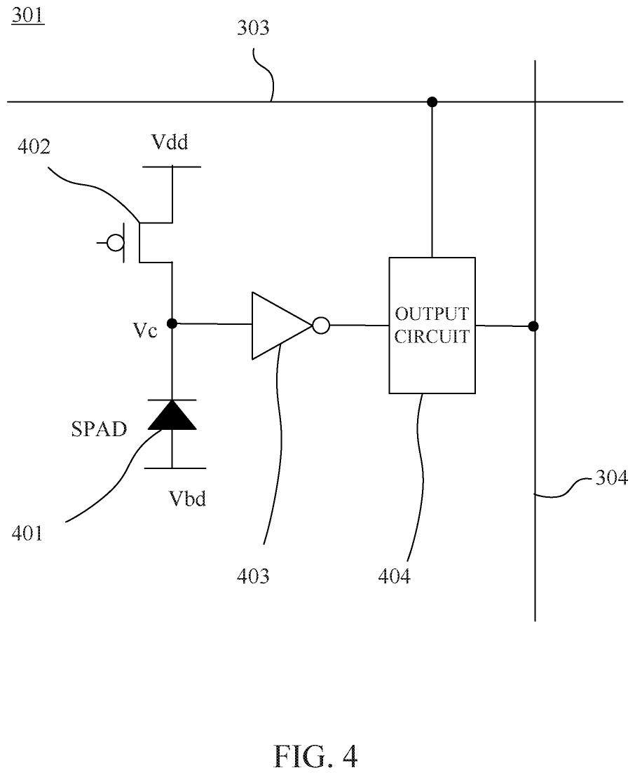

FIG. 4 illustrates the configuration of the pixel 301. The pixel 301 includes a Single Photon Avalanche Diode (SPAD) 401 serving as a light receiving element, a load transistor 402, an inverter 403, a pixel output circuit 404, a row selection pulse wiring 303, and a pixel output line 304. The SPAD 401 includes a light receiving region and an avalanche region.

Light incident on the SPAD 401, that is, photons, are photoelectrically converted in the light receiving region, whereby electrons and holes are generated. Positively charged holes are discharged via an anode electrode Vbd. Negatively charged electrons are transported as signal charges to the avalanche region by an electric field set so that potential decreases toward the avalanche region in the light receiving region. Signal charges that have reached the avalanche region cause avalanche breakdown due to a strong electric field in the avalanche region, whereby an avalanche current is generated.

When no avalanche current flows, the voltage of the anode electrode Vbd is set such that a reverse bias equal to or higher than a breakdown voltage is applied to the avalanche region of the SPAD 401. At this time, since no current flows through the load transistor 402, a cathode potential Vc becomes a voltage close to a power supply voltage Vdd, and an inverter output signal is “0.”

When an avalanche current is generated in the SPAD 401 upon the arrival of a photon, the cathode potential Vc decreases and the output of the inverter 403 is inverted. That is, the inverter output changes from “0” to “1.” When the cathode potential Vc decreases, the reverse bias applied to the SPAD 401 decreases, and generation of the avalanche current stops when the reverse bias becomes equal to or lower than the breakdown voltage.

Thereafter, when a hole current flows from the power supply voltage Vdd to the cathode potential Vc via the load transistor 402, the cathode potential Vc rises, the inverter output returns from “1” to “0,” and the state prior to arrival of the photon is restored.

Further, in a pixel 301 in which the row selection pulse wiring 303 is turned on, the output of the inverter 403 is controlled so as to be output from the pixel output circuit 404 to the pixel output line 304. In a pixel 301 in which the row selection pulse wiring 303 is turned off, the inverter output is controlled so as to be disconnected from the pixel output line 304. Therefore, only light incident on a specific row (light receiving element row) selected by the row selection circuit 125 can be detected by the pixels 301.

In this manner, pixel output signals corresponding to light detection in the plurality of pixels 301 belonging to the row selected by the row selection circuit 125 are output to the TDC array unit 122 as digital signals having low delay.

In the TDC array unit 122, the time from when the light emitting element array 111 emits light to when the pixel output signal changes from “0” to “1” is measured as ToF.

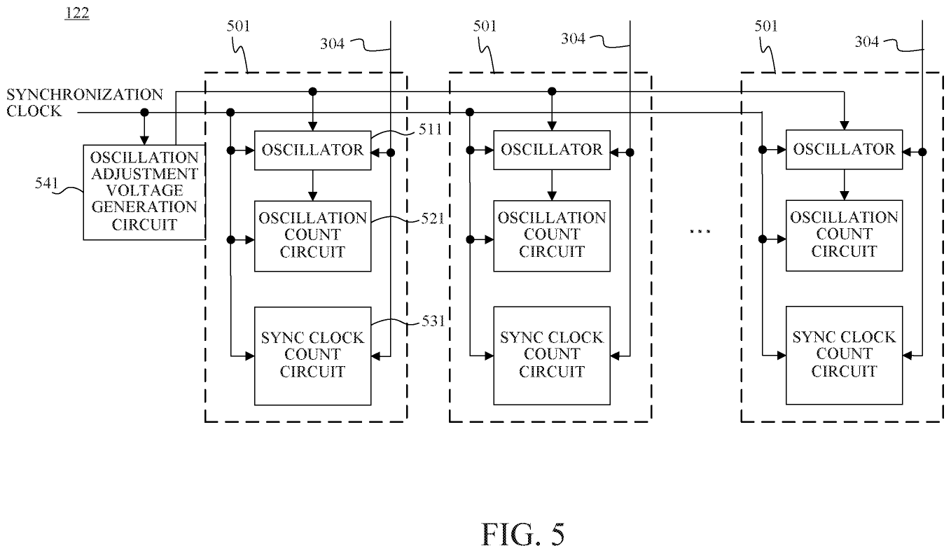

FIG. 5 schematically illustrates the TDC array unit 122. In the TDC array unit 122, TDCs 501 are provided in a number twice the number of pixels 301 in a horizontal direction of the light receiving element array 121, and pixel output signals from two rows of pixels 301 are measured simultaneously. Of these two rows of pixels 301, one row is used as pixels that detect signal light from the object, and the other row of pixels 301 is used as pixels that detect reference light.

Each TDC 501 includes an oscillator 511, an oscillation count circuit 521, and a synchronization clock count circuit 531. A count value in the synchronization clock count circuit 531 serves as the upper bits, an internal signal of the oscillator 511 serves as the lower bits, and a count value in the oscillation count circuit 521 serves as intermediate bits. That is, the pixel output signal is roughly measured by the synchronization clock count circuit 531, more finely measured by the internal signal of the oscillator 511, and the intermediate portion is measured by the oscillation count circuit 521. Redundant bits may be provided for each of the upper bits and the intermediate bits.

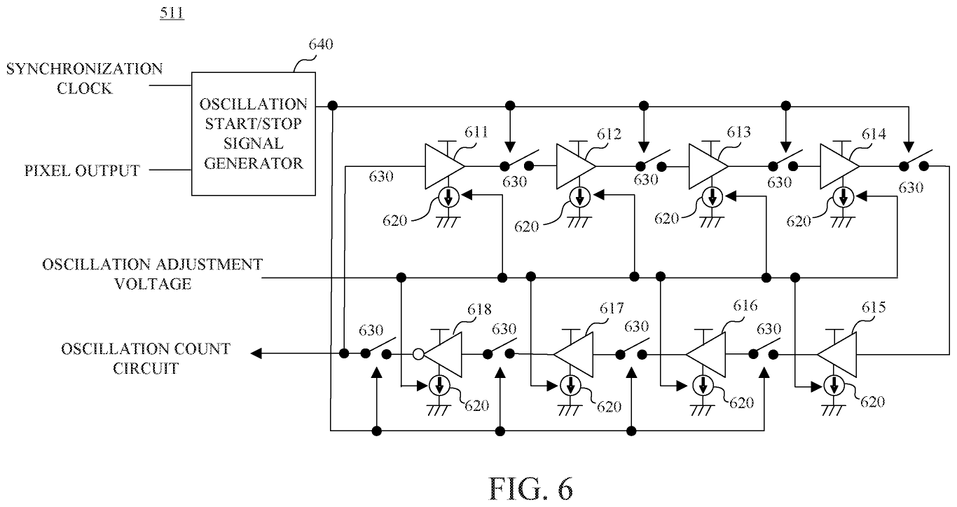

FIG. 6 schematically illustrates the configuration of the oscillator 511 of the TDC 501. The oscillator 511 includes an oscillation start/stop signal generator 640, buffers 611 to 618, an oscillation switch 630, and a delay adjustment current source 620. The buffers 611 to 618 and the oscillation switch 630 are alternately connected in a loop with eight stages each.

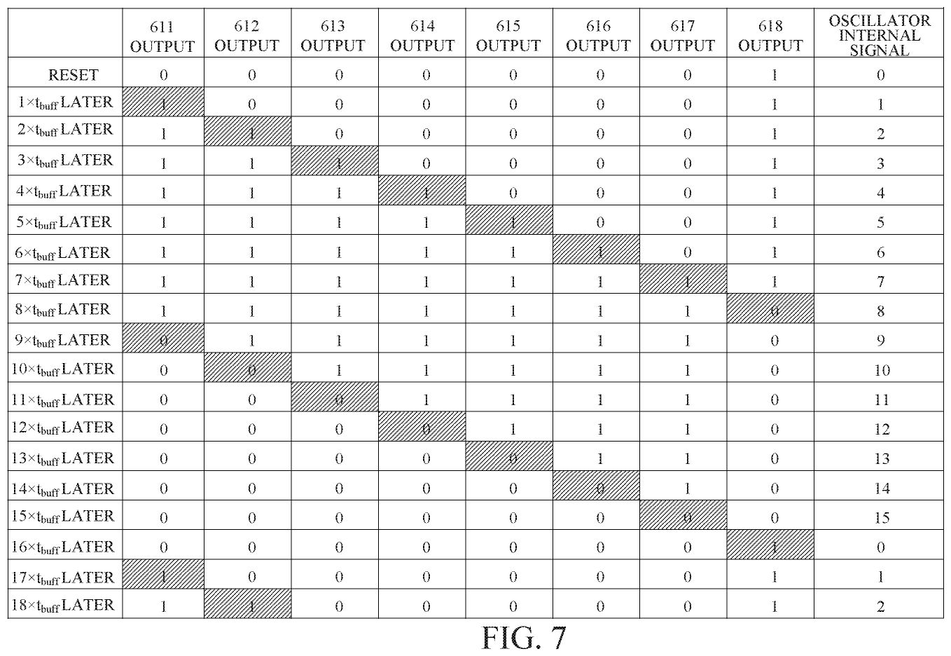

FIG. 7 illustrates output signals of the buffers 611 to 618 and internal signals of the oscillator 511 at reset, and output signals of the buffers 611 to 618 and internal signals of the oscillator 511 after a predetermined time has elapsed since the oscillation switch 630 is turned on.

At reset, outputs of the buffers 611 to 617 are set to “0” and an output of the buffer 618 is set to “1.” After a delay time t_{buff} corresponding to one buffer stage has elapsed since the oscillation switch 630 is turned on, the outputs of the buffers 612 to 618 whose input/output matching is satisfied do not change, and only the output of the buffer 611 whose input/output matching is not satisfied changes from “0” to “1” (the signal advances by one stage). After another delay time t_{buff} corresponding to one buffer stage has elapsed (after 2×t_{buff}), the outputs of the buffers 611 and 613 to 618 whose input/output matching is satisfied do not change, and only the output of the buffer 612 whose input/output matching is not satisfied changes from “0” to “1.” In this manner, every delay time t_{buff} corresponding to one buffer stage, an output of one buffer whose input/output matching is not satisfied changes sequentially. After 8×t_{buff} has elapsed since the oscillation switch 630 is turned on, the outputs of all buffers 611 to 618 change (the signal makes one round). After 16×t_{buff}, the outputs of all buffers further change (the signal makes two rounds) and return to the original state. Thereafter, the same operation is repeated every 16×t_{buff}. In this manner, the time measurement with a time resolution of t_{buff} is performed. This time resolution t_{buff} is adjusted to be ½⁷ of the synchronization clock by an oscillation adjustment voltage generation circuit 541 described later.

Further, an oscillator output, which is an output of the buffer 618, is input to the oscillation count circuit 521. By counting leading edges of the oscillator output in the oscillation count circuit 521, the time measurement with a time resolution of 16×t_{buff} is performed.

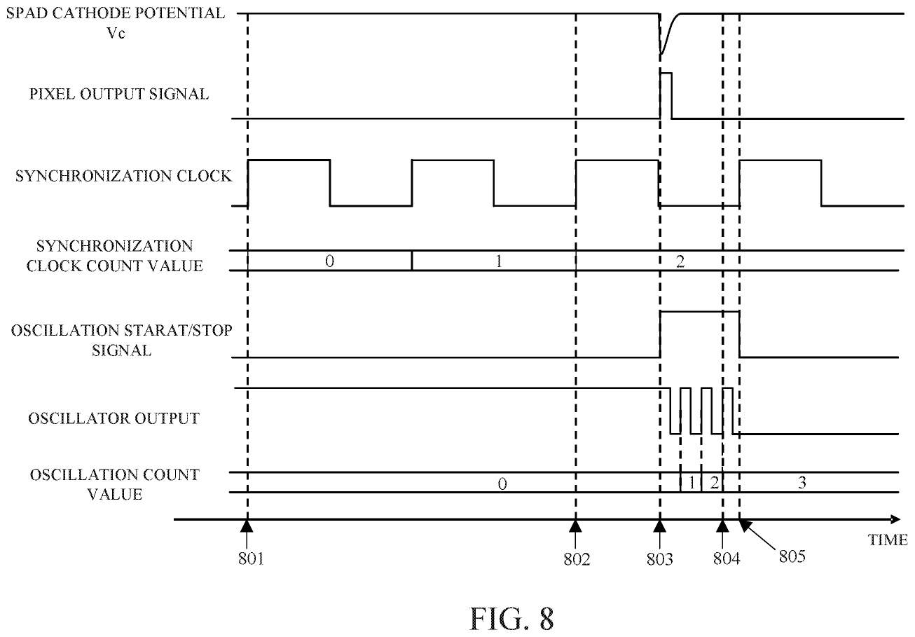

FIG. 8 illustrates the changes in the SPAD cathode potential Vc, a pixel output signal, a synchronization clock, a synchronization clock count value, an output of the oscillation start/stop signal generator 640 (oscillation start/stop signal), an oscillator output, and a count value in the oscillation count circuit 521 (oscillation count value) from a time when the light emitting element 201 belonging to a specific row of the light emitting element array 111 emits light to a time when the SPAD 401 receives light and a counting operation of the TDC 501 ends. The SPAD cathode potential Vc is an analog voltage, and a higher position in FIG. 8 indicates a higher potential. The synchronization clock, oscillation start/stop signal, and oscillator output are digital signals, and an upper position in the drawing indicates a turning-on state while a lower position indicates a turning-off state. The synchronization clock count value and oscillation count value are digital values indicated by decimal numbers.

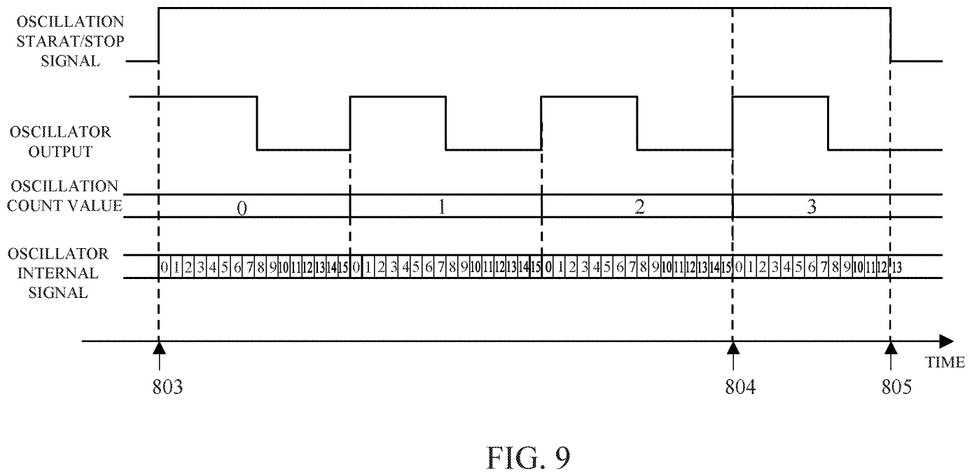

FIG. 9 illustrates the oscillation start/stop signal, oscillator output, oscillator count value, and an internal signal of the oscillator 511 (oscillator internal signal) from time 803 to time 805 in FIG. 8. The oscillator internal signal is a digital value indicated by a decimal number.

Referring now to FIGS. 8 and 9, a description will be given of a measurement operation (TDC operation) of the TDC 501 during a time from time 801 when the light emitting element 201 belonging to a specific row of the light emitting element array 111 emits light to time 803 when the SPAD 401 in the pixel 301 receives light (photons).

At time 801 aligned with a leading-edge timing of the synchronization clock supplied via the overall control unit 140 illustrated in FIG. 1, a light emission signal indicating a light emission instruction is output from the overall control unit 140 to the light source unit 113. The synchronization clock count circuit 531 illustrated in FIG. 5 starts counting leading edges of the synchronization clock from the time when the light emission signal is input.

When a photon reflected by the object is received by the SPAD 401 at time 803, the SPAD cathode potential Vc decreases and the pixel output signal changes from “0” to “1.” In response to the pixel output signal becoming “1, ” the oscillation start/stop signal changes from “0” to “1, ” and the oscillation switch 630 is turned on. When the oscillation switch 630 is turned on, the oscillator 511 starts an oscillation operation, and a loop of the oscillator internal signal starts as illustrated in FIG. 9. Every time the oscillator internal signal makes two rounds, a leading edge appears in the oscillator output, and the oscillation count circuit 521 counts the number thereof. Further, at time 803, the synchronization clock count circuit 531 stops counting and stores the count value at that time.

After the oscillation switch 630 is turned on, the timing at which the leading edge of the synchronization clock appears for the first time is time 805. In response to the leading edge of the synchronization clock, the oscillation start/stop signal becomes “0,” and the oscillation switch 630 is turned off. At the timing at which the oscillation switch 630 is turned off, the oscillation of the oscillator 511 ends, and the oscillator internal signal is stored as it is. Further, since the oscillation stops, counting in the oscillation count circuit 521 is also stopped.

In this manner, the synchronization clock count value D_{Gclk}, which is a count result of the synchronization clock count circuit 531, is a value obtained by counting the time from time 801 to time 802 in units of 2⁷×t^{buff}. Further, the oscillation count value D_{ROclk}, which is a count result of the oscillation count circuit 521, is a value obtained by counting a time from time 803 to time 804 in units of 2⁴×t_{buff}. Furthermore, the oscillator internal signal D_{ROin} is a value obtained by counting a time from time 804 to time 805 in units of t_{buff}. The TDC 501 performs the following processing using these count values D_{Gclk} and D_{ROclk} and the oscillator internal signal D_{ROin}, and completes one TDC operation by outputting a count value D_{ToF} after the processing to the signal processing unit 123.

First, the oscillation count value D_{ROclk} and the oscillator internal signal D_{ROin} are added together as in the following equation (2):

D_{RO}=2⁴×D_{ROclk}+D_{ROin} (2)

D_{RO} is a value obtained by counting the time from time 804 to time 805 in units of t_{buff}, and the time from time 802 to time 805 is a period of the synchronization clock and is equal to 2⁷×t_{buff}. Therefore, as in the following equation (3), D_{RO} is subtracted from the synchronization clock, and the result is added to D_{Gclk}. Thereby, a count value D_{ToF} obtained by counting the flight time of light (the time from time 801 to time 803) in units of t_{buff} is obtained.

D_{ToF}=2⁷×D_{Gclk}+(2⁷−D_{RO})=2⁷×D_{Gclk}+(2⁷−2⁴×D_{ROclk}−D_{ROin}) (3)

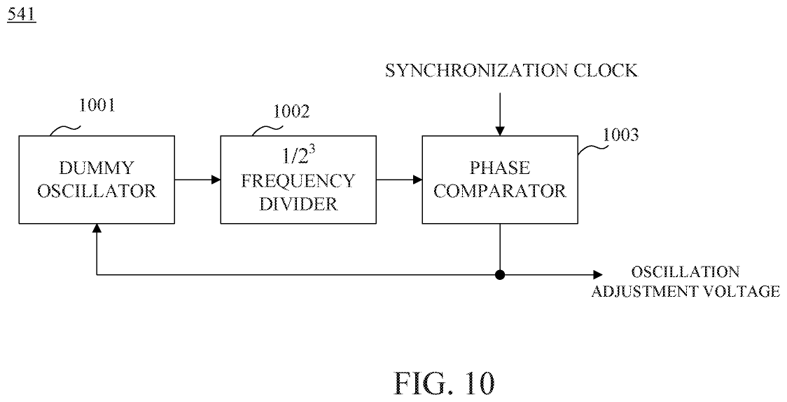

The delay time t_{buff} corresponding to one buffer stage varies due to process factors such as manufacturing variations of transistors, fluctuations in a voltage applied to the TDC 501, and temperature. Therefore, as illustrated in FIG. 5, the TDC array unit 122 is provided with an oscillation adjustment voltage generation circuit 541. As illustrated in FIG. 10, the oscillation adjustment voltage generation circuit 541 includes a dummy oscillator 1001, a ½³ frequency divider 1002, and a phase comparator 1003. The dummy oscillator 1001 is the same oscillator as the oscillator 511 mounted in the TDC 501.

The output of the dummy oscillator 1001 is input to the ½³ frequency divider 1002. The ½³ frequency divider 1002 outputs a clock signal having a clock frequency equal to ½³ of the input clock frequency. The phase comparator 1003 receives the synchronization clock and the clock signal from the ½³ frequency divider 1002. The phase comparator 1003 compares the frequency of the synchronization clock with the frequency of the clock signal from the ½³ frequency divider 1002, increases an output voltage in a case where the frequency of the synchronization clock is high, and decreases the output voltage in a case where the frequency of the synchronization clock is low. By inputting the output voltage of the phase comparator 1003 to the delay adjustment current source 620 of the oscillator 511, the oscillation frequency of the oscillator 511 is adjusted to be 2³ times the frequency of the synchronization clock.

In this manner, since the oscillation frequency of the oscillator 511 is determined based on the frequency of the synchronization clock, the synchronization clock may be generated based on an output (clock) from an external IC capable of outputting a constant frequency regardless of the above-described process factors, voltage fluctuations, and temperature. Thereby, fluctuations in the frequency of the synchronization clock due to the above-described process factors, applied voltage, and temperature can be suppressed.

For example, by inputting, as the synchronization clock to the oscillator 511, a clock having a frequency of 160 MHz from an external IC, the oscillation frequency becomes 1.28 GHz, which is eight times the synchronization clock frequency. The delay time t_{buff} corresponding to one buffer stage, which is the time resolution, is 48.8 ps.

### Optical Paths of Reference Light and Signal Light

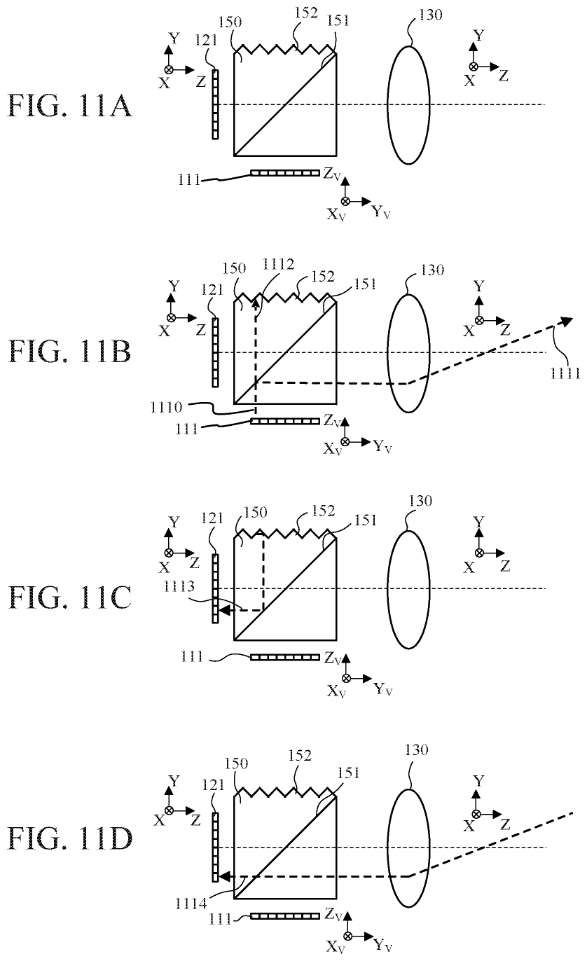

FIG. 11A schematically illustrates the beam splitter 150, the light emitting element array 111, the light receiving element array 121, and the imaging lens 130. The light emitting element array 111 and the light receiving element array 121 are in a conjugate relationship via the half-mirror 151 of the beam splitter 150 (so that they are optically conjugated with each other with respect to the half-mirror 151), and the respective light emitting elements and the respective light receiving elements are also in a one-to-one conjugate relationship, thereby being associated with each other. Row numbers in the light emitting element array 111 are assigned in ascending order from a smaller Yv side to a larger Yv side in FIG. 11A, and row numbers in the light receiving element array 121 are assigned in ascending order from a smaller Y side to a larger Y side in FIG. 11A. A light emitting element and a light receiving element having the same row number are in a conjugate relationship.

The number of rows (8) of the light emitting element array 111 and the light receiving element array 121 illustrated in FIG. 11A is merely an example, and another number of rows may be used. Further, the configuration is not limited to a configuration in which the light emitting elements and the light receiving elements are in a one-to-one conjugate relationship, and the number of light receiving elements may be n×n times the number of light emitting elements such that one light emitting element and n×n light receiving elements are in a conjugate relationship.

FIG. 11B illustrates an optical path of light emitted from a light emitting element (first light emitting element) of row number 1 in the light emitting element array 111. Light 1110 emitted from the light emitting element is split into irradiation light 1111 that is reflected by the half-mirror 151 of the beam splitter 150 and irradiated onto the object, and reference light 1112 that passes through the half-mirror 151 and travels toward the reflection structure portion 152 of the beam splitter 150.

FIG. 11C illustrates an optical path of the reference light 1113 reflected by the reflection structure portion 152 so as to return to the half-mirror 151. FIG. 11D illustrates an optical path of signal light 1114 returning after the irradiation light is reflected by the object. The signal light 1114 from the object enters a light receiving element (first light receiving element) that is in a conjugate relationship with the light emitting element that emitted light. On the other hand, the reference light 1113 reflected by the half-mirror 151 enters a light receiving element (second light receiving element) in a row adjacent to a row of the light receiving element that is in a conjugate relationship with the light emitting element that emitted light.

The reflection structure portion 152 has a structure on its surface, in which reflectance for light in a predetermined wavelength region including a wavelength of light from the light emitting element is higher than reflectance for light in other wavelength regions, and light in the other wavelength regions is transmitted and/or absorbed. The surface structure may be a structure in which dielectrics having different refractive indices are laminated, or may be a structure using an absorbing material such as metal. Further, the reflection structure portion 152 has a triangular periodic structure having a period twice an interval of the light emitting elements in a row direction, and has the same shape in a depth direction perpendicular to the plane of the drawing. The reflection structure portion 152 may instead have a semi-cylindrical periodic structure having the above period.

The reflection structure portion 152 having such a shape returns the reflected reference light 1113 to the half-mirror 151 while shifting the reflected reference light 1113 by one row relative to the incident reference light 1112. Then, the reference light 1113 reflected by the half-mirror 151 enters a light receiving element in a row adjacent to a row of the light receiving element that is in a conjugate relationship with the light emitting element that emitted the light 1110. A row of the light receiving elements that receives the reference light 1113 is a row corresponding to one of two rows corresponding to the period of the reflection structure portion 152 and having a Yv coordinate different from that of the light emitting element that emitted light.

In distance measuring processing described later, a distance measurement error due to a shift in a light emission timing of the light emitting element relative to the light emission instruction is reduced by subtracting a time from output of the light emission instruction signal to reception of the reference light 1113 from a time from the output of the light emission instruction signal to the reception of the signal light 1114. Although light emitted from the light emitting element of row number 1 has been described here, the same applies to light emitted from a light emitting element of another row number.

### Distance Measurement Processing

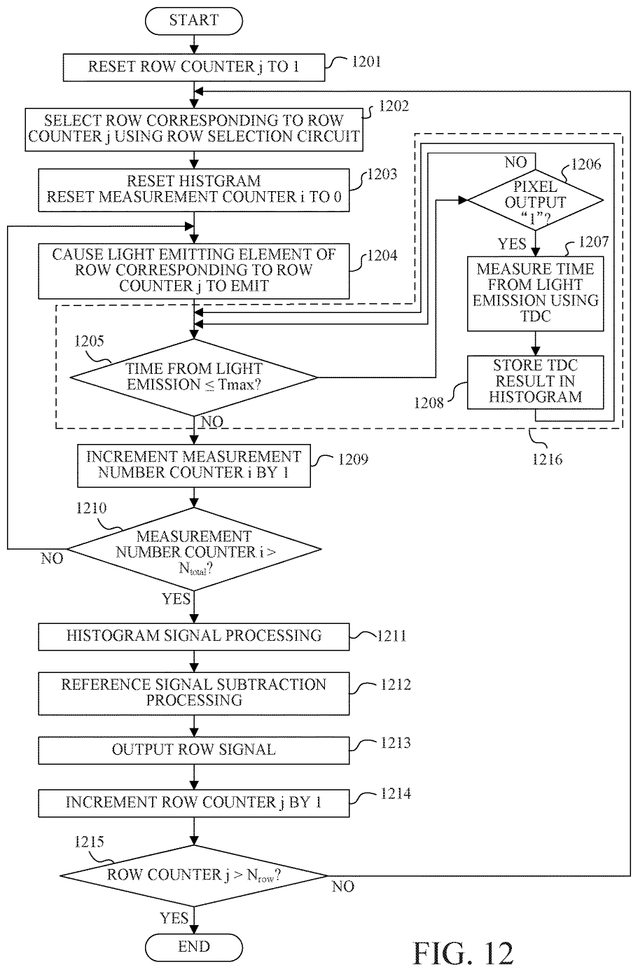

FIG. 12 illustrates distance measuring processing (measurement method) executed by the overall control unit 140 via the light source control unit 114 and the measurement control unit 124. The overall control unit 140, the light source control unit 114, and the measurement control unit 124 may be configured as a single computer such as a CPU, or may be configured by separate computers.

First, in step 1201, the overall control unit 140 resets a row counter j to 1.

Next, in step 1202, the overall control unit 140 causes, via the measurement control unit 124, the row selection circuit 125 to select a row of the pixels 301 corresponding to the row counter j and an adjacent row thereof. Thereby, pixel output signals from the pixels 301 of a row receiving signal light and the pixels 301 of the adjacent row receiving reference light are set to be output to the TDC array unit 122 via the pixel output lines 304.

Next, in step 1203, the overall control unit 140 causes, via the measurement control unit 124, the signal processing unit 123 to reset histogram circuits disposed therein in the same number as the TDCs. Further, the overall control unit 140 resets a measurement number counter i to 0.

Next, in step 1204, the overall control unit 140 causes the light source control unit 114 to output a light emission instruction signal for causing light emitting elements belonging to a row corresponding to the row counter j to emit light via the row driving circuit 202 of that row. Here, simultaneously with outputting the light emission instruction signal, the overall control unit 140 causes, via the measurement control unit 124, the TDCs 501 of the corresponding row and the adjacent row in the TDC array unit 122 to start the TDC operation.

Next, in step 1205, the overall control unit 140 determines whether a time from output of the light emission instruction signal is equal to or less than Tmax, which is a time corresponding to a maximum measurable distance, and, in a case where the time exceeds Tmax, performs processing of step 1209 described later. In a case where the time from output of the light emission instruction signal is equal to or less than Tmax, the flow waits in step 1206 until the pixel output signal becomes “1.”

During this waiting, the signal light reflected by the object and returned is incident on and received by the light receiving element that is in a conjugate relationship with the light emitting element that emitted light. When this reception causes the pixel output signal to become “1, ” in step 1207, a time from emission of the light emitting element to reception by the light receiving element is measured by the TDC 501.

Thereafter, in step 1208, a measurement result (TDC result) obtained by the TDC 501 is stored in a histogram, and the flow returns to the waiting state. In processing from light emission in step 1204 to step 1209 (step 1216 indicated by a broken line in the drawing), each light receiving element, each TDC 501, and each histogram circuit individually perform measurement and histogram calculation operations in response to a change in pixel output due to light reception.

On the other hand, in step 1209, the overall control unit 140 increments the measurement number counter i by 1.

Next, in step 1210, the overall control unit 140 determines whether the value of the measurement number counter i is greater than a predetermined number Nₜₒₜₐₗ. In a case where the value of the measurement number counter i is smaller than the predetermined number Nₜₒₜₐₗ, the determination in step 1205 is performed again. In a case where the value is greater than the predetermined number Nₜₒₜₐₗ, the flow proceeds to step 1211.

In step 1211, the overall control unit 140 causes, via the measurement control unit 124, the signal processing unit 123 to perform histogram processing for calculating, from the histogram of the TDC results, a reference-light time (first time) from the light emission instruction to detection of the reference light and a signal-light time (second time) from the light emission instruction to the detection of the signal light. In the histogram processing, intensity of the signal light, the intensity of ambient light, and the like are also calculated.

Next, in step 1212, the overall control unit 140 calculates (acquires) ToF by subtracting the reference-light time obtained in step 1211 from the signal-light time obtained in step 1211. Details of this subtraction processing will be described later.

Next, in step 1213, the overall control unit 140 causes the measurement control unit 124 to calculate distance information by substituting ToF calculated in step 1212 into equation (1), and acquires it. Through the processing from step 1202 to step 1213, distance measurement using one row of light emitting/light receiving elements is completed.

Next, in step 1214, the overall control unit 140 increments the row counter j by 1.

Next, in step 1215, the overall control unit 140 determines whether the row counter j is greater than a predetermined number of rows Nrow (for example, Nrow=8 as illustrated in FIG. 11A). In a case where the value is smaller than the predetermined number Nrow, the processing of step 1204 is performed again to perform distance measurement for the next row. When the row counter j reaches the predetermined number of rows Nrow and the distance measurement for all rows is completed, the measurement processing ends.

Through the above distance measuring processing, two-dimensional-array distance measurement results similar to image information can be obtained.

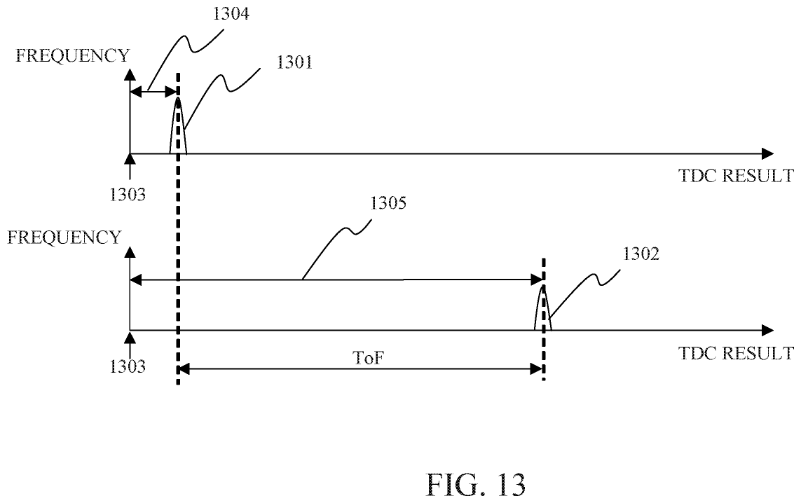

FIG. 13 illustrates an example of a reference-light histogram 1301 and a signal-light histogram 1302 obtained by storing, in a histogram circuit, a TDC result for reference light and a TDC result for signal light for a predetermined number Nₜₒₜₐₗ of times, respectively. Time 1303 indicates a time at which a light emission instruction signal is output from the overall control unit 140. A time 1304 from time 1303 to a peak time of the reference-light histogram 1301 is a reference-light time from the output of the light emission instruction signal to the actual light emission of the light emitting element. A time from time 1303 to a peak time of the signal-light histogram 1302 is a signal-light time 1305 from the output of the light emission instruction signal to the reception of the signal light from the object. In step 1212 of FIG. 12, by subtracting the reference-light time 1304 from the signal-light time 1305, a highly accurate ToF, that is, distance information to the object, can be obtained regardless of variation in a light emission delay time of the light emitting element from the light emission instruction.

As described above, in the present embodiment, the light emitting elements in the light emitting element array 111 are caused to emit light row by row at different times. Further, the beam splitter 150 has the reflection structure portion 152 for guiding reference light to a light receiving element in a row different from a row corresponding to the row of the light emitting element that emitted light among the light receiving element array 121, that is, different from a light receiving element that receives signal light. As a result, the signal light and the reference light can be received by the light receiving elements in the row corresponding to the row of the emitted light emitting element among the light receiving element array 121 and the light receiving elements in a row adjacent thereto, respectively. Thereby, highly accurate distance measurement can be performed in a compact distance measuring apparatus while reducing the influence of light emission delay of the light emitting element.

The light receiving element that receives the reference light is not necessarily required to belong to a row adjacent to the light receiving element that receives the signal light. That is, the reflection structure portion 152 may reflect the reference light such that the reference light is guided to a light receiving element different from the light receiving element that receives the signal light.

Further, in the light emitting element array, the light emitting elements are not necessarily caused to emit light sequentially for each single row, and the light emitting elements may be caused to emit light sequentially for every two or more rows. That is, the light emitting elements may be caused to emit light sequentially for every predetermined number of rows.

### Second Embodiment

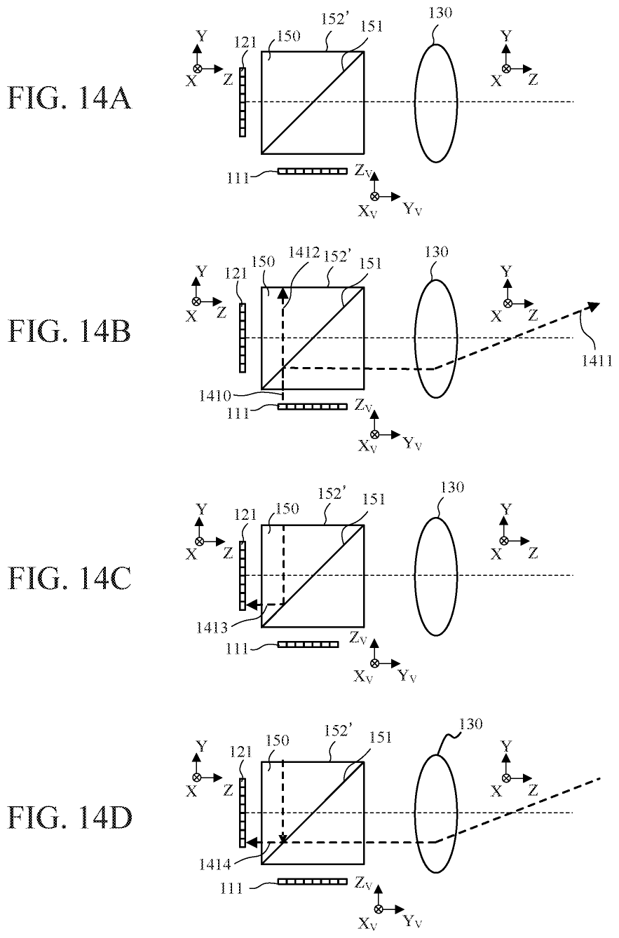

FIG. 14A schematically illustrates the beam splitter 150, the light emitting element array 111, the light receiving element array 121, and the imaging lens 130 in the second embodiment. Also in this embodiment, the light emitting element array 111 and the light receiving element array 121 are in a conjugate relationship via the half-mirror 151 of the beam splitter 150, and each light emitting element and each light receiving element are also in a one-to-one conjugate relationship. Row numbers in the light emitting element array 111 and the light receiving element array 121 are the same as those described with reference to FIG. 11A.

In this embodiment, the reflection structure portion 152′ provided in the beam splitter 150 differs from the reflection structure portion 152 in the first embodiment. As described with reference to FIGS. 11B and 11C, the reflection structure portion 152 in the first embodiment has a structure that reflects the reference light 1112 (1113) incident from the half-mirror 151 onto the reflection structure portion 152 so as to shift the reference light by one row. In contrast, the reflection structure portion 152′ in the second embodiment has a structure that does not generate a one-row shift in the reference light. On a surface of the reflection structure portion 152′, a structure is provided such that, for light in a predetermined wavelength region including the wavelength of light from the light emitting element, reflectance becomes lower than reflectance for light in other wavelength regions, and the light in the other wavelength regions is transmitted, absorbed, or both. This surface structure may be a structure in which dielectrics having different refractive indices are stacked, or may be a structure using an absorbing material such as metal.

As illustrated in FIG. 14B, light 1410 emitted from a light emitting element of row number 1 (first light receiving element) in the light emitting element array 111 is split into irradiation light 1411 reflected by the half-mirror 151 and reference light 1412 transmitted through the half-mirror 151. The reference light 1412 enters the reflection structure portion 152′. As illustrated in FIG. 14C, reference light 1413 reflected by the reflection structure portion 152′ enters the half-mirror 151 through the same optical path as the reference light 1412 incident on the reflection structure portion 152′, and is reflected by the half-mirror 151 toward the light receiving element array 121. As a result, as understood from FIGS. 14C and 14D, the reference light 1413 enters the light receiving element (first light receiving element) that is in a conjugate relationship with the emitted light emitting element. That is, the reference light 1413 enters the same light receiving element as the light receiving element on which the signal light 1414 from the object is incident.

In this embodiment, in step 1202 of the flowchart illustrated in FIG. 12, the overall control unit 140 causes, via the measurement control unit 124, the row selection circuit 125 to select only the row of pixels 301 corresponding to the row counter j. Thereby, the configuration is set such that pixel output signals from the pixels 301 in the row receiving the signal light and the reference light are output to the TDC array unit 122 via the pixel output lines 304.

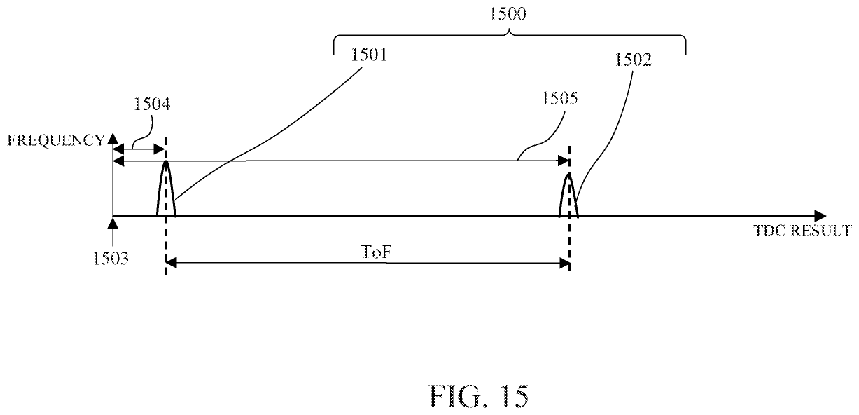

FIG. 15 illustrates an example of a reference-light/signal-light histogram obtained by storing TDC results for a predetermined number Nₜₒₜₐₗ of times in the histogram circuit. Time 1503 indicates a time at which a light emission instruction signal is output from the overall control unit 140. The first embodiment (FIG. 13) obtains the reference-light histogram 1301 and the signal-light histogram 1302 using the TDC results obtained from the pixels 301 in the row conjugate with the row of the emitted light emitting element and an adjacent row thereto. In contrast, this embodiment obtains a reference-light/signal-light histogram 1500 in which the reference-light histogram and the signal-light histogram are combined, using only the TDC results obtained from the pixels 301 in the row conjugate with the row of the emitted light emitting element.

The reference-light/signal-light histogram 1500 includes two peaks. A peak 1501 having a shorter time from time 1503 is a reference-light peak, and a peak 1502 having a longer time from time 1503 is a signal-light peak. A time 1504 from time 1503 to the time of the reference-light peak 1501 is a reference-light time from the output of the light emission instruction signal to the actual light emission of the light emitting element. A time from time 1503 to the time of the signal-light peak 1502 is a signal-light time 1505 from the output of the light emission instruction signal to the reception of signal light from the object. In step 1212 of FIG. 12, by subtracting the reference-light time 1504 from the signal-light time 1505, a highly accurate ToF, that is, distance information to the object, can be obtained regardless of variation in a light emission delay time of the light emitting element from the light emission instruction.

As described above, this embodiment causes the light emitting elements in the light emitting element array 111 to emit light row by row at different times. Further, the beam splitter 150 includes the reflection structure portion 152′ for guiding the reference light to the light receiving elements in the row corresponding to the row of the emitted light emitting element among the light receiving element array 121. As a result, the signal light and the reference light can be received with a time difference by the light receiving elements in the row corresponding to the row of the emitted light emitting element among the light receiving element array 121. Thereby, a compact distance measuring apparatus can perform highly accurate distance measurement while reducing an influence of light emission delay of the light emitting element.

In the above embodiments, the reflection structure portions 152 and 152′ serving as reflector are integrally provided in the beam splitter 150. However, similar reflector may be provided separately from the beam splitter. In this case, the size of the distance measuring apparatus can be reduced by placing the reflector so as to contact or be close to the beam splitter.

The distance measuring apparatus (measurement apparatus) described in the above embodiments can be included in a processing apparatus that is mounted in various apparatuses such as an image pickup apparatus such as a camera, an electronic apparatus such as a smartphone, a moving apparatus such as an automobile, and that performs processing using distance information (information on an object) obtained from the distance measuring apparatus. In the image pickup apparatus or electronic apparatus, for example, the processing apparatus can perform focus control (autofocus (AF)) using distance data may be performed or a distance map in an angle of view, as described above. In the moving apparatus, the processing apparatus can form a part of an Electronic Control Unit (ECU) that measures a distance from a preceding vehicle, controls a brake and a steering wheel by detecting an obstacle, warning output, and the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. One or more of the functional blocks illustrated in FIG. 1 may be implemented by hardware such as an ASIC or a programmable logic array (PLA), or by a programmable processor such as a CPU or MPU executing software. They may also be implemented by a combination of software and hardware. Therefore, even when different functional blocks are described as the main operation entities in the following description, they may be implemented by the same hardware.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. A measurement apparatus comprising:
a light emitting element array including a plurality of light emitting elements;
a light receiving element array including a plurality of light receiving elements;
an optical system;
a light splitting element including a splitter configured to split light from the light emitting element array into irradiation light to be irradiated onto an object via the optical system and reference light to be guided to the light receiving element array, the light splitting element being configured to guide, via the splitter, signal light, which is reflected by the object among the irradiation light and incident via the optical system, to the light receiving element array;
one or more memories storing instructions;
one or more processors that, upon execution of the instructions, operate to acquire information on the object using a first time from a light emission instruction to the light emitting element array to reception of the reference light by the light receiving element array and a second time from the light emission instruction to reception of the signal light by the light receiving element array; and
a reflector configured to reflect the reference light from the splitter back to the splitter,
wherein the reference light from the reflector is guided to the light receiving element array via the splitter.

2. The measurement apparatus according to claim 1, wherein the reflector is integrally provided in the light splitting element.

3. The measurement apparatus according to claim 1, wherein the reference light reflected by the object among the irradiation light from a first light emitting element in the light emitting element array is guided, via the splitter, to a first light receiving element corresponding to the first light emitting element in the light receiving element array, and
wherein the reflector reflects the reference light from the first light emitting element such that the reference light is guided, via the splitter, to a second light receiving element different from the first light receiving element in the light receiving element array.

4. The measurement apparatus according to claim 3, wherein, in the light emitting element array, the plurality of light emitting elements are two-dimensionally arranged so as to form a plurality of light emitting element rows, and in the light receiving element array, the plurality of light receiving elements are two-dimensionally arranged so as to form a plurality of light receiving element rows,
wherein, in the light emitting element array, simultaneous light emission of a plurality of first light emitting elements belonging to a same light emitting element row is sequentially performed for each predetermined number of light emitting element rows, and
wherein the reflector reflects the reference light from the plurality of first light emitting elements such that the reference light is guided, via the splitter, to the plurality of second light receiving elements belonging to a light receiving element row different from a light receiving element row corresponding to the light emitting element row to which the plurality of first light emitting elements belong in the light receiving element array.

5. The measurement apparatus according to claim 3, wherein the reflector has a structure configured to shift the reference light reflected by the reflector relative to the reference light incident on the reflector.

6. The measurement apparatus according to claim 1, wherein the reference light reflected by the object among the irradiation light from a first light emitting element in the light emitting element array is guided, via the splitter, to a first light receiving element corresponding to the first light emitting element in the light receiving element array, and
wherein the reflector reflects the reference light from the first light emitting element such that the reference light is guided, via the splitter, to the first light receiving element.

7. The measurement apparatus according to claim 6, wherein, in the light emitting element array, the plurality of light emitting elements are two-dimensionally arranged so as to form a plurality of light emitting element rows, and in the light receiving element array, the plurality of light receiving elements are two-dimensionally arranged so as to form a plurality of light receiving element rows,
wherein, in the light emitting element array, simultaneous light emission of a plurality of first light emitting elements belonging to a same light emitting element row is sequentially performed for each predetermined number of light emitting element rows, and
wherein the reflector reflects the reference light from the plurality of first light emitting elements such that the reference light is guided, via the splitter, to the plurality of second light receiving elements belonging to a light receiving element row corresponding to a light emitting element row to which the plurality of first light emitting elements belong in the light receiving element array.

8. The measurement apparatus according to claim 1, wherein each light emitting element in the light emitting element array and each light receiving element in the light receiving element array are associated with each other by being arranged at positions optically conjugate to each other with respect to the splitter.

9. The measurement apparatus according to claim 1, wherein the reflector has a structure configured to perform at least one of transmission and absorption for light in a wavelength region different from a wavelength region including a wavelength of the reference light.

10. The measurement apparatus according to claim 1, wherein the one or more processors operate to acquires distance information as the information on the object using a flight time obtained by subtracting the first time from the second time.

11. A processing apparatus comprising a measurement apparatus,
wherein the measurement apparatus includes:
a light emitting element array including a plurality of light emitting elements;
a light receiving element array including a plurality of light receiving elements;
an optical system;
a light splitting element including a splitter configured to split light from the light emitting element array into irradiation light to be irradiated onto an object via the optical system and reference light to be guided to the light receiving element array, the light splitting element being configured to guide, via the splitter, signal light, which is reflected by the object among the irradiation light and incident via the optical system, to the light receiving element array;
one or more memories storing instructions;
one or more processors that, upon execution of the instructions, operate to acquire information on the object using a first time from a light emission instruction to the light emitting element array to reception of the reference light by the light receiving element array and a second time from the light emission instruction to reception of the signal light by the light receiving element array; and
a reflector configured to reflect the reference light from the splitter back to the splitter,
wherein the reference light from the reflector is guided to the light receiving element array via the splitter, and
wherein the processing apparatus performs processing using the information on the object.

12. A measurement method using:
a light emitting element array including a plurality of light emitting elements;
a light receiving element array including a plurality of light receiving elements;
an optical system;
a light splitting element including a splitter configured to split light from the light emitting element array into irradiation light to be irradiated onto an object via the optical system and reference light to be guided to the light receiving element array, the light splitting element being configured to guide, via the splitter, signal light, which is reflected by the object among the irradiation light and incident via the optical system, to the light receiving element array; and
a reflector configured to reflect the reference light from the splitter back to the splitter, the reference light from the reflector being guided to the light receiving element array via the splitter,
the measurement method comprising:
acquiring information on the object using a first time from a light emission instruction to the light emitting element array to reception of the reference light by the light receiving element array and a second time from the light emission instruction to reception of the signal light by the light receiving element array.
